(19) United States
(12) Patent Application Publication
(10) Pub. No.: US 2025/0233620 A1
(43) Pub. Date: Jul. 17, 2025

(54) METHODS AND APPARATUS FOR JOINT PRECODING IN COORDINATED OPERATION OF USER EQUIPMENT (UE)

(71) Applicant: Huawei Technologies Co., Ltd., Shenzhen (CN)

(72) Inventors: Hua Xu, Ottawa (CA); Jianglei Ma, Ottawa (CA)

(21) Appl. No.: 19/095,994

(22) Filed: Mar. 31, 2025

Related U.S. Application Data
(63) Continuation of application No. PCT/CN2023/123092, filed on Oct. 4, 2023.
(60) Provisional application No. 63/415,367, filed on Oct. 12, 2022.

(51) Int. Cl. H04B 7/024; H04B 7/0456; H04L 5/00

(52) U.S. Cl. CPC H04B 7/024; H04B 7/0456; H04L 5/0026

(57) ABSTRACT

Operation of user equipment (UE) is to be coordinated with one or more other UEs for joint precoding and transmission of data to a communication device in a wireless communication network. Relationship information indicating a relationship between different reference signals that are communicated between a UE and the communication device or a relationship between a reference signal and a corresponding antenna beam for the transmission of data after the precoding is communicated in the wireless communication network. The UEs transmit the data after the joint precoding has been applied to the data, and the communication device receives transmissions of the data from the UEs.

### CROSS-REFERENCE TO RELATED APPLICATIONS

This application is a continuation of International Application No. PCT/CN2023/123092, entitled “METHODS AND APPARATUS FOR JOINT PRECODING IN COORDINATED OPERATION OF USER EQUIPMENT (UE),” filed on Oct. 4, 2023, which claims priority to U.S. provisional patent application Ser. No. 63/415,367, entitled “METHODS AND APPARATUS FOR JOINT PRECODING IN COORDINATED OPERATION OF USER EQUIPMENT (UE),” filed on Oct. 12, 2022, both of which are hereby incorporated by reference in their entireties.

### TECHNICAL FIELD

The present application relates generally to wireless communications, and more specifically to coordinated operation of user equipment (UE) with joint precoding by multiple UEs.

### BACKGROUND

In conventional wireless communication systems, each UE within a cell or coverage area of a network device such as a base station typically transmits to and receives from the network device by itself. In this sense, such systems may be referred to as being cell-centric.

Direct UE-to-UE communication has been studied and specified in the form of device-to-device (D2D) communications, to improve communications between UEs. UE cooperation is targeted more toward a group of UEs working together to improve transmission to and/or reception from a base station, as well as between UEs. UE cooperation is therefore more UE-centric in design, and could complement features in a cell-centric system and improve overall system performance and capacity for downlink (DL) communications from base stations to UEs, uplink (UL) communications from UEs to base stations, and/or sidelink communications between an other UE to and from the UEs.

UE cooperation (UC) is currently a new subject in the 3^{rd} generation partnership project (3GPP). Although some studies and specification focus on the sidelink (SL) based relay and UE aggregation, at present this is more a preliminary work from the UE cooperation perspective and requires further study. For example, coordinating UEs in a group of UEs for UC, in terms of DL/UL/SL transmission/reception operations and functions, has not been studied.

### SUMMARY

The present disclosure encompasses embodiments related to joint precoding (JP), including joint precoding procedures and corresponding signaling for UC. For example, a common structure and baseband procedure for UE JP transmission may involve common data dispatching or distributing among UEs, such as dispatching transport blocks or other blocks of data from a common medium access control (MAC) entity or other higher layer entity to multiple physical (PHY) layer entities or other lower layer entities located on each UE. Related PHY layer procedures are also disclosed by way of example.

Some disclosed embodiments may exploit quasi co-location (QCL), and involve QCL signaling for UE JP. As QCL signaling examples, downlink control information (DCI) designs for UE JP, including transmission configuration indication (TCI) information, are disclosed.

UE JP embodiments disclosed herein include not only UL embodiments in which JP is applied by cooperating UEs for UL transmission, but also SL embodiments in which JP is applied by cooperating UEs for UL transmission to an other UE.

Features related to configured grant (CG) for JP are also disclosed herein.

According to an aspect of the present disclosure, a method involves obtaining, by a first UE for which operation is to be coordinated with a second UE for joint precoding and transmission of data to a communication device, precoding information indicative of precoding that is to be applied to the data by the first UE as part of the joint precoding. Such a method may also involve communicating, by the first UE with the communication device, relationship information indicating a relationship between different reference signals that are communicated between the first UE and the communication device or a relationship between a reference signal and an antenna beam for the transmission of the data after the precoding; and transmitting, by the first UE to the communication device, the data after the precoding has been applied to the data by the first UE.

In another embodiment, a method involves communicating, by a communication device, relationship information indicating: a relationship between different reference signals that are communicated between the communication device and each UE of a plurality of UEs for which operation is to be coordinated for joint precoding and transmission of data to the communication device, or a relationship between a reference signal and an antenna beam for the transmission of the data to the communication device by each UE of the plurality of UEs after precoding of the data by each UE of the plurality of UEs as part of the joint precoding. Such a method may also involve receiving, by the communication device from the plurality of UEs, the data after the joint precoding and transmission of the data by the plurality of UEs.

In apparatus embodiments, an apparatus may include a processor and a non-transitory computer readable storage medium that is coupled to the processor. The non-transitory computer readable storage medium stores programming for execution by the processor. The apparatus may be, in various embodiments, a UE, a network device, one or more components in a UE, one or more components in a network device, a chipset in a UE, or a chipset in a network device, for example.

A storage medium need not necessarily or only be implemented in or in conjunction with such an apparatus. A computer program product, for example, may be or include a non-transitory computer readable medium storing programming for execution by a processor.

Programming stored by a computer readable storage medium may include instructions to, or to cause a processor to, perform, implement, support, or enable any of the methods disclosed herein.

For example, the programming may include instructions to, or to cause a processor to: obtain, by a first UE for which operation is to be coordinated with a second UE for joint precoding and transmission of data to a communication device, precoding information indicative of precoding that is to be applied to the data by the first UE as part of the joint precoding; communicate, by the first UE with the communication device, relationship information indicating a relationship between different reference signals that are communicated between the first UE and the communication device or a relationship between a reference signal and an antenna beam for the transmission of the data after the precoding; and transmit, by the first UE to the communication device, the data after the precoding has been applied to the data by the first UE.

In another embodiment, programming includes instructions to, or to cause a processor to: communicate, by a communication device, relationship information indicating: a relationship between different reference signals that are communicated between the communication device and each UE of a plurality of UEs for which operation is to be coordinated for joint precoding and transmission of data to the communication device, or a relationship between a reference signal and an antenna beam for the transmission of the data to the communication device by each UE of the plurality of UEs after precoding of the data by each UE of the plurality of UEs as part of the joint precoding; and receive, by the communication device from the plurality of UEs, the data after the joint precoding and transmission of the data by the plurality of UEs.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a block diagram of an example communication system illustrating multiple communication paths or links.

FIG. 6 is a block diagram of another example communication system illustrating multiple communication paths or links.

FIG. 7 is a block illustrating data dispatching according to an embodiment.

FIG. 8 is a block diagram illustrating baseband processing for joint precoding and transmission according to an embodiment.

FIG. 9 is a block diagram illustrating joint precoding according to an embodiment.

FIG. 10 is a block diagram illustrating QCL configuration/indication for uplink according to an embodiment.

FIG. 11 is a block diagram illustrating QCL configuration/indication for sidelink according to another embodiment.

FIG. 12 is a block diagram illustrating example signaling options.

FIG. 13 is a signal flow diagram illustrating an example of signaling and coordinated operation of UEs for joint precoding and transmission of data according to an embodiment.

FIG. 14 is a signal flow diagram illustrating an example of signaling and coordinated operation of UEs for joint precoding and transmission of data according to another embodiment.

FIG. 15 is a block diagram illustrating an example of a telecommunications network according to one embodiment.

FIG. 16 is a block diagram illustrating an example of a network serving two UEs.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

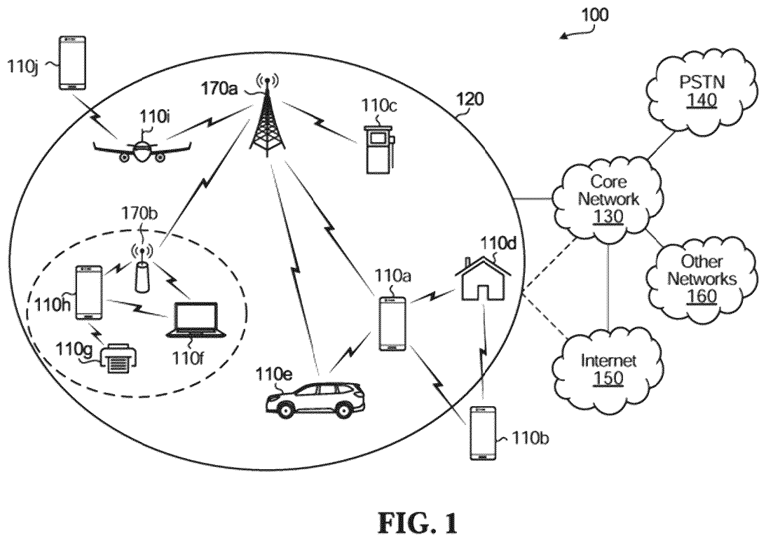

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

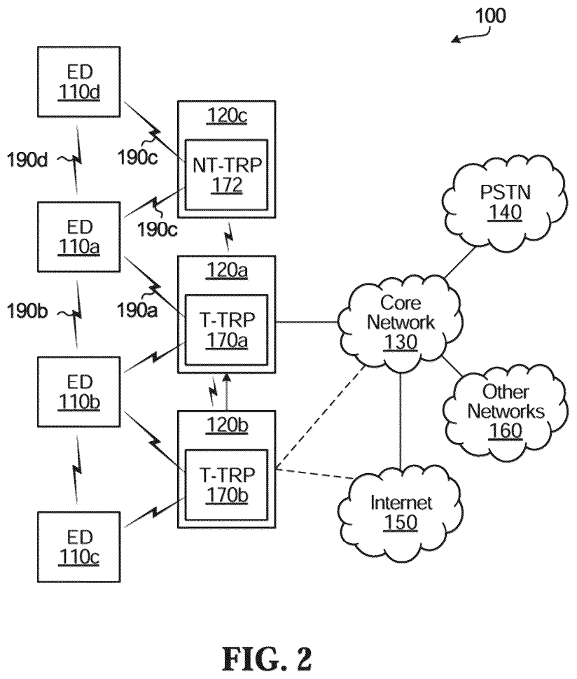

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

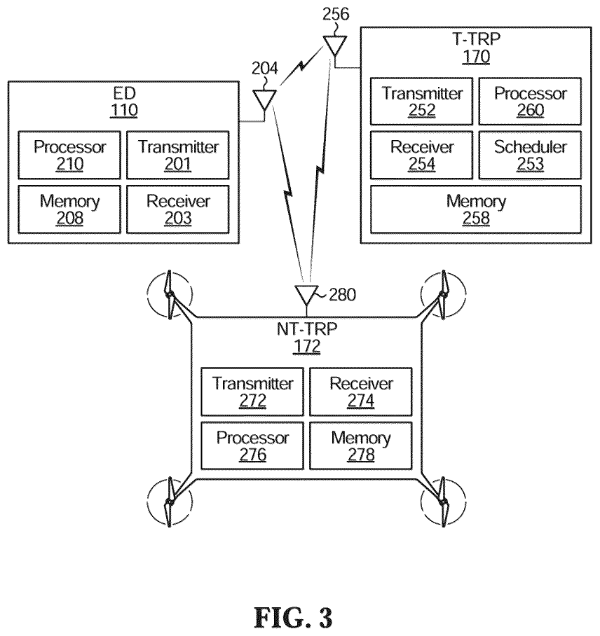

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

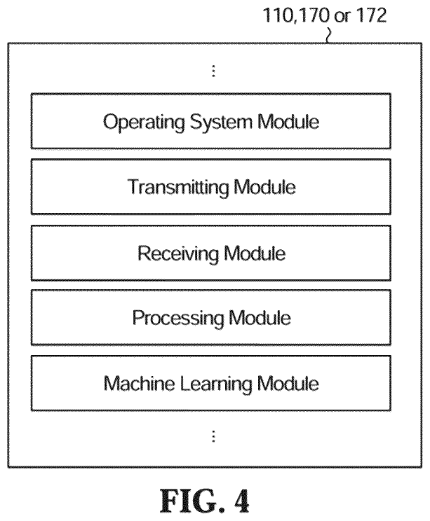

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Having considered communications more generally above, attention will now turn to particular example embodiments.

UC could benefit from improved transmit power/spatial diversity/multiplexing. However, one potential drawback in highly correlated channels is that UE transmissions for UC using non-coherent joint transmission (NCJT) experience strong inter-UE interference, and thus suffer from performance loss. To help mitigate this issue, JP could be utilized among UEs that are participating in UC.

In general, compared with NCJT in which each UE that is participating in UC generates and applies precoding separately, joint precoding means that the participating UEs apply precoding together. This could overcome, or at least reduce, the effects of inter-UE interference on UC performance. JP is used primarily herein to refer to participating UEs applying precoding together (“jointly”), but JP may also or instead be referred in other ways. For example, JP may be referred to as coherent joint transmission (CJT), as opposed to NCJT, to capture a notion that the transmissions from UEs participating in UC in a CJT approach are coherent joint transmissions instead non-coherent joint transmissions from each UE in an NCJT approach.

A possible way to apply JP for cooperative UL transmission is on how to generate a joint precoder for UC but without providing detail on how to apply the joint precoder for JP. The present disclosure provides, among other aspects or embodiments, simplified procedures for applying joint precoding and related signaling to facilitate the joint precoding and improve performance. QCL is used in some embodiments to indicate a relationship of reference signals and other known signals, with a demodulation reference signal (DMRS) signal or port for example, to facilitate decoding of data channels such as physical downlink shared channel (PDSCH). Currently, QCL information is used in multi-TRP DL transmission and is carried by DCI. For JP as disclosed herein, multiple UEs may transmit different sets of reference signals and DMRS respectively, and their relationships can be indicated to or otherwise obtained by a receiver end to facilitate decoding.

As used herein, coordinated operation of UEs is intended to encompass cooperative operation between UEs such as UC, but is not limited only to UC. UEs that are configured for coordinated operation with each other may be part of a UC group or participate in UC, but embodiments herein are not in any way limited to coordinated operation that is specifically referred to as UC. Coordinated operation may include UC, but is not limited to UC. In other words, UC may be an example of coordinated operation, but coordinated operation may also or instead be implemented or supported in other ways that may not necessarily be referred to as UC.

For coordinated operation, different UEs may be configured with different operations, features, or functions for transmission and/or reception, such as to apply different parts of a common precoder or to apply different but related precoders for example. Configuration for coordinated operation of UEs may be semi-static or dynamically signaled, or explicitly or implicitly indicated. Embodiments for configuring UEs for coordinated operation include embodiments in which one or more UEs are configured by a network device such as a gNB, and/or embodiments in which a UE such as a primary UE is involved in configuring one or more other UEs.

These and other embodiments are described in detail herein.

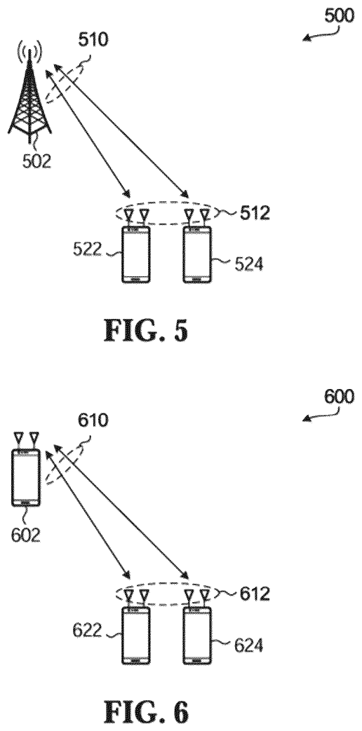

FIG. 5 is a block diagram of an example communication system illustrating multiple communication paths or links. The example system 500 includes a network device 502, and UEs 522, 524, which are to participate in coordinated operation. Communications between the UEs 522, 524 and the network equipment 502 are through direct communication paths or links shown by way of example as “Uu” links 510 in FIG. 5, and the UEs may communicate directly with each other through a UE-to-UE communication link (or inter-UE connection or link) between the UEs. The UE-to-UE communication link is not shown in FIG. 5 in order to avoid further congestion in the drawing. Such a UE-to-UE communication link may be, but is not limited to, a sidelink for example. Examples and implementation options for network devices, UEs, and links are provided elsewhere herein. The network device 502 may be a network device or equipment such as a network node 170a, 170b in FIG. 1 and 2 or 170 in FIGS. 3 and 4 or an access node 172 in FIGS. 2 to 4, and the UEs may be EDs 110a-c in FIG. 1 and 2 or 110 in FIGS. 3 and 4, for example.

As one application of UE coordination, in UC operation, the UEs 522 and 524 could work together to help with transmission and/or reception for one of the UEs, for example UE 522, which could be referred as a source UE (SUE, for uplink transmission) or a target UE (TUE, for downlink reception). For uplink UC, one portion of data from the SUE could be transmitted directly to the network device 502 via Uu link 510, and the same or another portion of the data from the SUE could be transmitted indirectly to the network device 502 via another UE 524 (first via the UE-to-UE link to the UE 524, then relayed by the UE 524 via Uu link 510). For downlink UC, data destined to the TUE could be transmitted directly from the network device 502 via Uu link 510 to the TUE (522), while it (or another portion of the data) could be transmitted indirectly from the network device 502 to the TUE via another UE 524 (first via the Uu link 510 to the UE 524, then relayed by the UE 524 via the UE-UE link).

FIG. 5 represents a scenario in which both of the UEs 522, 524 are “in-coverage” (within a geographical area of direct communication with the network device 502). There is a Uu path or link between the network device 502 and each UE 522, 524 in the example shown. The UEs 522, 524 are also connected to each other by a UE-to-UE link. This is one possible embodiment, but other embodiments are also possible.

For example, FIG. 6 is a block diagram of another example communication system illustrating multiple communication paths or links. The example communication system 600 in FIG. 6 is substantially the same as the example shown in FIG. 5, in that it includes two UEs 622, 624, for which coordinated operation is to be configured. However, in FIG. 6 coordinated operation of the UEs 622, 624 is for communications with another UE 602 instead of with a network device as in FIG. 5. In FIG. 6, 610 represents a UE-to-UE link rather than a Uu link as at 510 in FIG. 5. The UE-to-UE link 610 may include, but is not limited to, a sidelink for example. The UEs 622, 624 may also communicate with each other over another such link (not shown). Examples and implementation options for UEs and links are provided elsewhere herein. The UEs may be EDs 110a-c in FIGS. 1 and 2 or 110 in FIGS. 3 and 4, for example.

UE coordination for inter-UE communications as in the system 600 may involve the UEs 622, 624 working together to help with transmission and/or reception for the UE 602, which could be referred as an SUE for transmissions from the UE 602 or a TUE for transmissions to the UE 602. One application of JP consistent with the present disclosure involves the UEs 622, 624 jointly precoding and transmitting data to the UE 602, in which case the UE 602 is a TUE and one of the UEs (or yet another UE, not shown) is an SUE.

Although the UEs 522, 524 in FIG. 5 are in-coverage, in FIG. 6 the UEs 602, 622, 624 may or may not be in-coverage. If operation of the UEs for UC is independent of a network device, then it is possible that the UEs may operate while all of them are out of coverage.

Regarding UC with joint precoding and transmission by multiple UEs, in general two or more UEs could apply joint precoding on data and transmit the data cooperatively. In the examples shown in FIGS. 5 and 6, reference numbers 512 and 612, respectively, are intended to represent JP applied across two UEs 522, 524 and 622, 624 respectively. The examples shown involve UEs with multiple antenna elements, but more generally a UE that is involved in JP and transmission may have one, or more than one, antenna element.

JP means that precoding among participating UEs is applied coherently, and may also be jointly generated. In contrast, in a conventional approach each UE could generate and apply precoding separately (or independently), which sometimes is also referred as separate precoding or NCJT. NCJT does not consider the relationship among channels that signals transmitted from each UE experience, and whether they are correlated or not. Therefore NJCT does not coordinate transmission of signals well from each UE, and may incur more mutual inter-UE interference among them. A consequence of this is more performance loss due to the inter-UE interference among UEs participating in UC.

JP for UC could be applied in two scenarios, shown by way of example in FIGS. 5 and 6. In the example of FIG. 5, data transmission utilizing UC could be on the Uu link 510 (or UL) to the gNB 502 (destination of the data), to improve Uu link performance between one or more of the UEs 522, 524 and the gNB. In the example of FIG. 6, data transmission by utilizing UC could be on sidelink (e.g., PC5), by the UEs 622, 624 to the UE 602 (or destination UE), namely applying JP for UE-to-UE communications to improve sidelink performance between UEs.

The joint precoding (JP) can be applied across antenna elements of each UE that is participating in joint precoding. As noted at least above, a UE that is participating in UC may have one, or more than one, antenna element.

Embodiments disclosed herein are not limited to any specific type of precoding. For example, either or both of code-book (CB) based and non code-book (NCB) based precoding could be used for joint precoding.

Consider, as an example, CB based joint precoding for UL communications in the communication system 500 in FIG. 5. The gNB 502 could configure joint sounding reference signal (SRS) transmission from the UEs 522, 524 participating the joint precoding on uplink. For example, the gNB 502 could send radio resource control (RRC) signaling to configure all UEs 522, 524 participating in UC to transmit SRS with the same period and time-offset, but using the same or different time/frequency/sequences resources. The UEs participating in UC with joint precoding could then transmit joint SRS signals to the gNB on UL. The gNB 502 could then derive joint precoding vectors based on channel estimation obtained from the received joint SRS signals and transmit them, as transmit precoding matrix index (TPMI) information and number of data layers for example, to one or more of the UEs 522, 524 in DCI, and the UEs apply joint precoding to data and transmit the data on UL to the gNB.

CB based joint precoding for SL communications in the communication system 600 in FIG. 6 may involve one of the participating UEs 622, 624 or potentially another UE, which may be referred to as a primary UE for example, configuring joint SL channel state information reference signal (SL CSI-RS) transmission from the participating UEs on SL. For example, the primary UE could send RRC signaling on sidelink to configure all UEs 622, 624 participating in UC to transmit SL CSI-RS signaling for the participating UEs with the same period and time-offset, but using the same or different time/frequency/sequences resources. The UEs participating in UC with joint precoding could then transmit joint SL CSI-RS signals to the destination UE 602. The destination UE 602 could then derive joint precoding vectors based on the channel estimation obtained from the received joint SL CSI-RS signals and transmit them, as TPMI information and number of data layers for example, to the primary UE or to one or more of the UEs 622, 624 on SL, and the participating UEs 622, 624 apply joint precoding to data and transmit the data on SL to the destination UE 602. The primary UE could be an SUE where data is originated, or could be another UE that organizes/monitors UC and JP transmission.

For NCB based joint precoding for uplink, with reference again to FIG. 5 the gNB 502 could transmit CSI-RS signals to each participating UE 522, 524 on DL, and each UE could measure the DL channel. A primary UE, which may be one of the participating UEs or another UE, could collect the measured DL channels from the participating UEs involved in joint precoding and derive joint precoding vectors for UL data transmission based on channel reciprocity property (e.g., TDD transmission) and share them with other UEs over inter-UE communication or SL. The participating UEs 522, 524 then apply joint precoding to data and transmit the data on UL to the gNB 502.

NCB based joint precoding for sidelink may be substantially similar. With reference to FIG. 6, a destination UE 602 could transmit SL CSI-RS signals to each participating UE 622, 624 on SL, and each participating UE 622, 624 could measure its SL channel with the destination UE. A primary UE, which again may be one of the participating UEs 622, 624 or another UE, could collect the measured SL channels from the participating UEs involved in joint precoding and derive joint precoding vectors and share them with other UEs over inter-UE communication or SL. The participating UEs 622, 624 then apply joint precoding to data and transmit the data on SL to the destination UE 602.

The foregoing is illustrative of how CB and NCB based joint precoding may be supported for UL and SL scenarios, to potentially improve performance.

As described elsewhere herein, JP has a potential advantage over non-JP or NCJT approaches because JP utilizes channel information that all participating UEs experience to facilitate joint precoding/transmission. However, JP involves obtaining relevant channel information to generate joint precoding information and apply precoding jointly across participating UEs. This can lead to more difficulty in realization and implementation. According to some embodiments, a joint precoding procedure facilitates JP implementation.

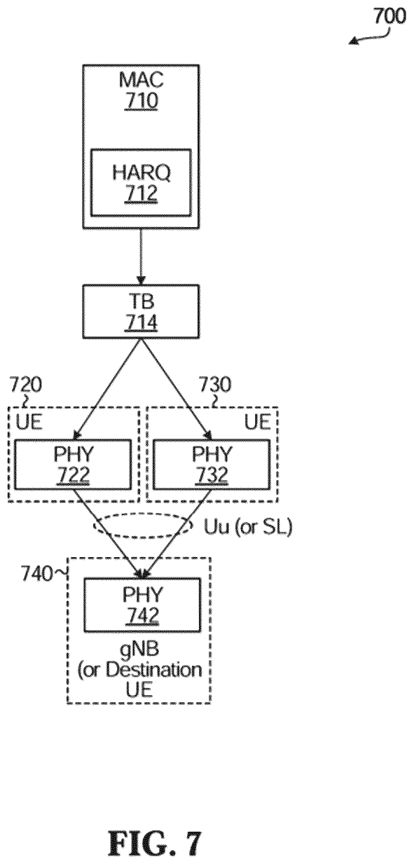

FIG. 7 is a block illustrating data dispatching or data flow according to an embodiment. In the example 700, 710 represents a MAC entity, with a hybrid automatic repeat request (HARQ) entity 712 for managing a HARQ process for a TB 714. Two participating UEs 720, 730 each have a respective PHY layer 722, 732, and joint precoding and transmission is to be performed to transmit the TB 714 to a gNB (for UL) or destination UE (for SL), shown at 740 with its own PHY layer 742.

The TB 714 is intended to generally represent the same TB or a same data block, of an information data packet for example, dispatched from a MAC (or other higher layer) entity to UEs 720, 730 participating in UC with joint precoding. The TB is managed by a joint HARQ process (with the same HARQ process ID) in MAC, and the joint HARQ process is operated by the HARQ entity 712 in FIG. 7. A HARQ entity may operate a number of HARQ process, such as 8, 16, or 32 HARQ processes for example, and each HARQ process manages a transmission and any re-transmissions for one TB at a time. The association between HARQ entity/HARQ process and a corresponding UE/physical shared channel such as physical uplink shared channel (PUSCH) for UL or physical sidelink shared channel PSSCH for SL could be configured or pre-defined.

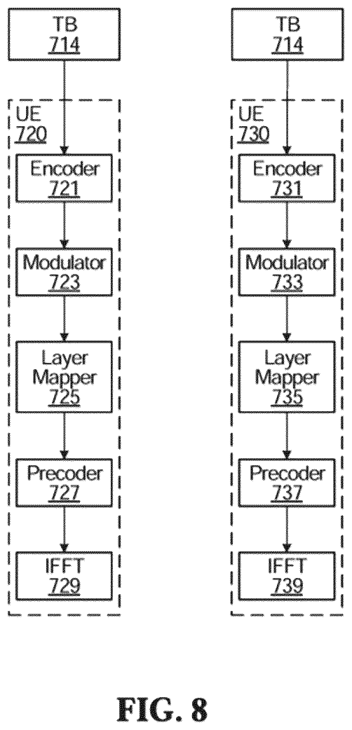

FIG. 8 is a block diagram illustrating baseband processing for joint precoding and transmission according to an embodiment. The example in FIG. 8 is consistent with the data dispatching shown in FIG. 7, in which the same TB 714 is dispatched to each of two participating UEs 720, 730 from the common MAC entity 710 (FIG. 7). Functions or features that the illustrated components of the UEs 720, 730 are designed, configured, or otherwise enabled to perform or support are described by way of example below. These components may be implemented in any of various ways as described elsewhere herein.

Baseband processing by each of two participating UEs 720, 730 is illustrated by way of example in FIG. 8. Other types of processing may also or instead be performed by UEs that participate in joint precoding, before or after or in between processing that the illustrated components are enabled to perform, and there may be more than two participating UEs. Also, although the UEs 720, 730 are shown with identical components in FIG. 7, this should not be taken as any form of indication that participating UEs are necessarily identical to each other.

The encoder 721, 731 of each UE 720, 730 represents a channel encoding for channel encoding. The same TB 714 is encoded by each channel encoder 721, 731 with the same coding rate respectively for each UE 720, 730 in some embodiments.

For modulation by the modulators 723, 733, channel encoded bits could be modulated by the same modulation and coding scheme (MCS) respectively for each UE 720, 730.

Each layer mapper 725, 735 is intended to represent a component to perform layer mapping. Here, layer is intended to refer to a layer or stream of data. Modulated symbols from each modulator 723, 733 preferably generate the same number of layers or data streams respectively for each UE 720, 730.

Each of the UEs 720, 730 in the example shown includes a precoder 727, 737 to apply precoding, and in some embodiments precoded data is converted to time domain and transmitted via one or more assigned antenna elements or ports, from each UE. The IFFT blocks 729, 739 are shown as an illustrative example of a frequency domain to time domain converter to convert to time domain by applying an inverse fast Fourier transform (IFFT).

For joint precoding, in some embodiments the same precoding matrix or precoder is used to apply precoding for each UE that is participating in UC with joint precoding. In a CB based approach, for example, the precoding matrix may be obtained by a participating UE based on a TPMI that is received from a gNB, a destination UE, or in some embodiments from a primary UE. An NCB based approach may involve a participating UE obtaining a precoding matrix by generating the precoding matrix or obtaining the precoding matrix based on precoding matrix information received from a primary UE.

When applying precoding, a compound codebook that can be used for applying joint precoding across an aggregate or combined set of antennas of all participating UEs can be used. However, each UE would then use only a respective different portion such as one or more rows of the precoding matrix to apply precoding for its own layers of data, to generate precoded data for transmission over those of its own antenna ports to be used for UC and joint transmission. The antenna port(s) of each UE to be used in JP and transmission could be configured or dynamically indicated.

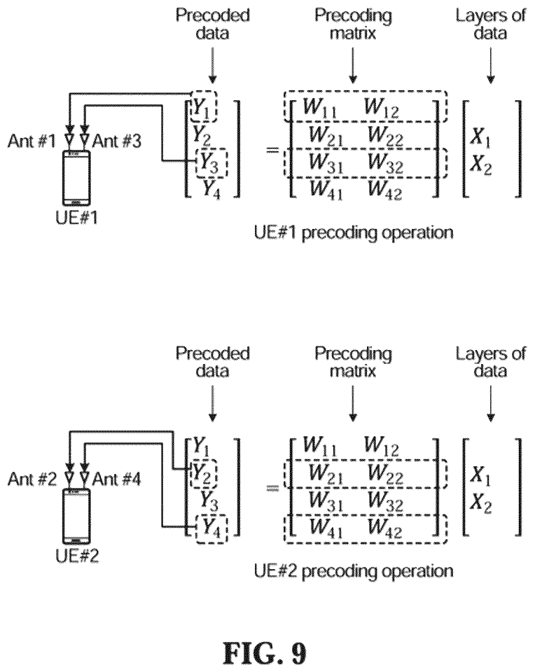

For example, FIG. 9 is a block diagram illustrating joint precoding according to an embodiment. In FIG. 9, a UE #1 has two transmit antennas and its antenna ports are configured (assigned) as antenna ports #1 and #3, respectively, for UC and UE #2 has two transmit antennas and its antenna ports are configured (assigned) as antenna ports #2 and #4, respectively, for UC. A compound codebook of precoding matrices supporting precoding of 4-tx could be used, and a precoding matrix is generally shown in FIG. 9.

Applying joint precoding in this example involves UE #1 applying precoding using the first and third rows of the precoding matrix on corresponding layers of data (multiplying the rows of precoding matrix with corresponding layers of data) to generate precoded data to be transmitted by UE #1 from assigned antenna ports #1 and #3, respectively. Similarly, UE #2 applies precoding using different rows, including the second and fourth rows, of the precoding matrix on corresponding layers of data to generate precoded data to be transmitted by UE #2 from assigned antenna ports #2 and #4, respectively.

This is one example, and others are possible. In another embodiment, the corresponding rows of the precoding matrix used by each UE could form a respective separate precoding matrix. For the row examples shown in FIG. 9, the first and third rows of a precoding matrix could form a new precoding matrix for UE #1 and the second and fourth rows of the precoding matrix could form a separate precoding matrix for UE #2. These separate precoding matrices could form different sets of codebooks and be configured (assigned) for different UEs.

It should be noted that for JP, each UE may apply precoding using a codebook for a total of the number of antennas of all UEs that are to be used for JP and joint transmission. In the example shown in FIG. 5, each of two participating UEs has 2-tx antennas and the total aggregated antenna number will be 4 for JP. Thus a 4-tx codebook may be used if UEs apply respective portions such as rows of the same precoding matrix. To support that, each UE participating JP may have the capability of supporting 4-tx codebook based precoding and such capability could be reported to a gNB, destination UE, or primary UE as part of a JP supporting capability.

In some embodiments, each UE participating in JP applies the same procedure in baseband of PHY to the same TB of data from a common MAC, which could be located on SUE where data is originated. The only difference in PHY of each participating UE may be that precoding is applied using a respective subset of different rows of the same precoding matrix (or a respective one of precoding matrices that are formed from the same precoding matrix) to generate precoded signals for corresponding antenna ports associated with each UE. That may make the implementation in PHY of each UE for JP very straightforward without significant changes to PHY implementation for single UE transmission.

Data dispatch, baseband processing, and joint precoding as disclosed by way of example herein may be advantageous in that there is no need for a PHY link between UEs for JP. A MAC (or higher) level data dispatch and simplified PHY process may also or instead provide more flexibility for UE cooperation transmission including JP.

For multi-UE joint precoding transmission on UL or SL, some reference signal ports are co-located on the same UE and/or are transmitted in the same antenna beams, and some are not because they could be located on different UEs or could be transmitted in different beams. Such information is indicated/configured to a receiver end in some embodiments, to facilitate joint channel estimation for decoding data for PUSCH on UL or PSSCH on SL. QCL relationships of different signals imply that they experience similar channel characteristics in the air. QCL is defined as follows: two antenna ports are said to be quasi co-located if properties of the channel over which a symbol on one antenna port is conveyed can be inferred from the channel over which a symbol on the other antenna port is conveyed. QCL information could also or instead be used to facilitate other features such as beam managing and/or beam switching (UL or SL) and CSI measurement.

Relationship information that is communicated between a transmit device and a receive device may indicate different types of relationships, but in general may facilitate decoding of received data by the receive device. A relationship between different reference signals is a different type of relationship from a relationship between a reference signal and an antenna beam. The first type of relationship may indicate, for example, that two reference signals are QCLed or otherwise co-located, so that they can be used together for decoding. The second type of relationship (reference signal and associated antenna beam) indicates that a UE will use an antenna beam that is associated with a reference signal for data transmission after precoding the data as part of joint precoding, and may in this way facilitate decoding of precoded and transmitted data. Thus, in general, relationship information may be communicated to facilitate decoding of data by a receiving device, but may indicate different types of relationships that may facilitate decoding in different ways.

Relationships or relationship information may help decoding of precoded data at a receiver side, but may be considered as not directly affecting or not being directly related to precoding of data at a transmitter side. Relationship information indicates a relationship between reference signals, or a relationship between a reference signal and an antenna beam, and is for use at a receiver side, to facilitate decoding of precoded data.

Obtaining precoding information and relationship information can occur at the same time as precoding information, or at different times, and relationship information can be carried by or otherwise indicated by the same DCI (SCI) or different DCI (SCI). There need not be any direct correspondence in time for these two actions, of obtaining precoding information and relationship information.

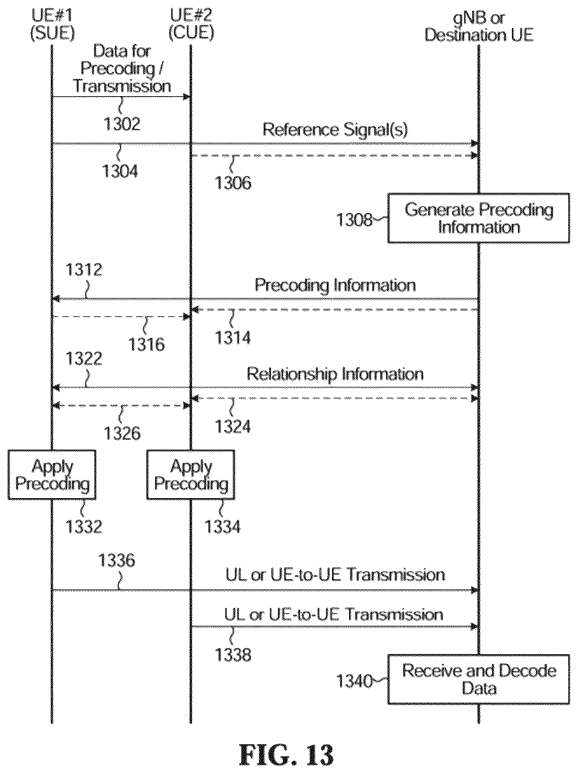

Two types of relationships are disclosed by way of example herein, including a first type of relationship between different reference signals (such as CSI/SRS and DMRS for example). Relationship information may be sent, by (or to) each transmitter such as UE #1 and UE #2 in FIG. 13 for example, to (or by) a receiver such as the gNB or destination UE in FIG. 13 for example. Whether the relationship information is communicated by (or to) each transmitting device, to (or by) a receiving device, the relationship information is communicated to facilitate decoding of joint precoded data at the receiving device. A second type of relationship is between a reference signal and an associated antenna beam, to indicate a particular beam associated with the specific reference signal indicated. Relationship information for such a relationship is communicated so that the antenna beam associated with an indicated reference signal is used to transmit precoded data.

Transmission of data may be considered to be based on relationships or relationship information in a broad sense, but precoding of data is not directly based on relationships or relationship information. Relationships disclosed herein are between different reference signals, or between reference signals and antenna beams. One way to envision precoding is to apply precoding on data. After the precoding, the data will be transmitted on an indicated beam (following a reference signal/beam relationship), along with a reference signal in the form of DMRS for example. Relationship information indicating another type of relationship can be communicated, to indicate that the DMRS and an other reference signal (such as SRS or CSI-RS) are QCLed for example. In this example, the received data can be decoded by or at a receiving device using the DMRS and its related reference signal(s) together.

Returning now to examples of relationship information and relationships, QCL information or TCI state information to indicate QCL relationships could be configured by using higher layer signaling such as RRC, for UC JP for either or both of UL scenario and SL scenario. Similar to new radio (NR) standard, a QCL or TCI state configuration can be referred to or indicated in a TCI field carried by DCI/SCI, by a gNB or other network device (for UL scenario) or a primary UE (for SL scenario), for example.

For example, as shown in Table 1 below, for each UE participating in JP for UL communications, denoted as UE #1 and UE #2 for ease of reference, TCI state (to indicate QCL relationship) can be configured for each UE by RRC. In the example below, the QCL relationship of some reference signals, including synchronization signal block (SSB), CSI-RS, and SRS, is configured for UE #1 (to be associated with DMRS port configured for UE #1 or associated with one or more beam directions in UL) and UE #2 (to be associated with DMRS port configured for UE #2 or associated with one or more beam directions in UL), respectively. PUCCH/PUSCH below refer to physical uplink control channel or physical uplink shared channel.

TABLE 1
RRC configuration example of TCI state for JP on UL

| | |
|---|---|
| UL_TCIState ::= | SEQUENCE { |
| ul-TCIState-Id | UL-TCIState-Id, |
| servingCellId | ServCellIndex |
| referenceSignal_UE#1 | CHOICE { |
| ssb-Index | SSB-Index, |
| csi-RS-Index | NZP-CSI-RS-ResourceId, |
| srs | PUCCH/PUSCH-SRS |
| }, | |
| referenceSignal_UE#2 | CHOICE { |
| ssb-Index | SSB-Index, |
| csi-RS-Index | NZP-CSI-RS-ResourceId, |
| srs | PUCCH/PUSCH-SRS |
| }, | |

As another example for SL, for each UE participating in JP, again denoted as UE #1 and UE #2, the TCI state can be configured for each UE by RRC. In the example provided below in Table 2, QCL relationship of some reference signals, in particular SL CSI-RS, are configured for UE #1 (to be associated with DMRS port configured for UE #1 or associated with one or more beam directions in SL) and UE #2 (to be associated with DMRS port configured for UE #2 or associated with one or more beam directions in SL), respectively.

TABLE 2
RRC configuration example of TCI state for JP on SL

| | |
|---|---|
| SL_TCIState ::= | SEQUENCE { |
| sl-TCIState-Id | SL-TCIState-Id, |
| referenceSignal_UE#1 | CHOICE { |
| SL-csi-RS-Index | |
| }, | |
| referenceSignal_UE#2 | CHOICE { |
| SL-csi-RS-Index | |
| }, | |

QCL information between different antenna ports such as SRS and DMRS ports for PUSCH on Uu, or between SL CSI-RS and DMRS ports for PSSCH on SL can be dynamically indicated, in DCI or sidelink control information (SCI) for example. Alternatively, the QCI state (TCI state) information can be configured by RRC and dynamically indicated further by DCI/SCI.

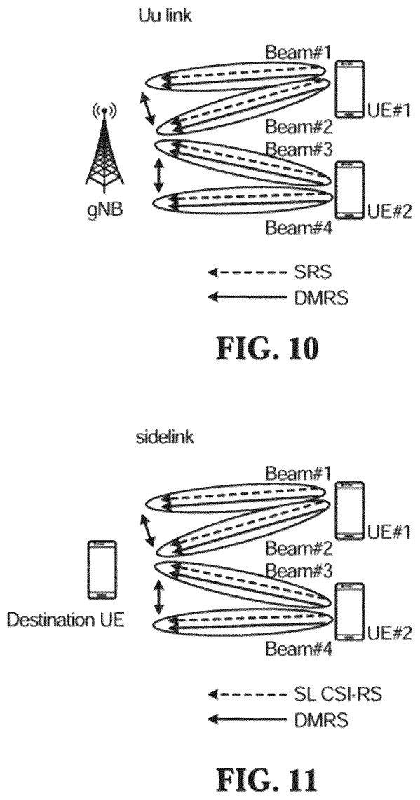

FIG. 10 is a block diagram illustrating QCL configuration/indication for uplink according to an embodiment. In the example shown, SRS ports (#1000 and #1002 for example) are configured for UE #1 beam #1 and beam #2, respectively, and are QCLed with DMRS port 0 and DMRS port 2 configured for UE #1 PUSCH on beam #1 and beam #2, respectively; and SRS ports (#1001 and #1003 for example) are configured for UE #2 beam #3 and beam #4, respectively, and are QCLed with DMRS port 1 and DMRS port 3 configured for UE #2 PUSCH on beam #3 and beam #4, respectively.

FIG. 11 is a block diagram illustrating QCL configuration/indication for sidelink according to another embodiment. In this example, SL CSI-RS ports (#3000 and #3002 for example) are configured for UE #1 beam #1 and beam #2, respectively, and are QCLed with DMRS port 1000 and DMRS port 1002 configured for UE #1 PSSCH on beam #1 and beam #2, respectively; and SL CSI-RS ports (#3001 and #3003 for example) are configured for UE #2 beam #3 and beam #4, respectively, and are QCLed with DMRS port 1001 and DMRS port 1003 configured for UE #2 PSSCH on beam #3 and beam #4, respectively.

Similar as QCL indication adopted in NR for DL multi-TRP transmission, for UL scenario and SL scenario UC with JP, QCL information could be dynamically indicated further by TCI (transmission configuration indication) field in DCI (for UL scenario or SL scenario) or SCI (for SL scenario). The SL scenario is referenced in the context DCI, here and elsewhere herein, because DCI could potentially be used for SL scheduling as well. For example, a network device such as a gNB may transmit DCI that includes or otherwise indicates scheduling information for SL, and then a participating UE could use such scheduling information in DCI to schedule SL transmission.

A QCL relationship may include a relationship of reference signal (SSB, RS, etc.) and DMRS for PUCCH/PUSCH/physical sidelink control channel (PSCCH)/PSSCH associated with different beams/UEs. Such relationships could be used for improving channel estimation when decoding PUSCH or PSSCH or for beam managing/switching for PUSCH or PSSCH, for example.

The TCI field could be activated/deactivated by a MAC control element (MAC-CE), and TCI values can be used to indicate QCL relationships of some reference signals (RS or SSB, etc.) with DMRS or relation of some reference signals or channels and associated beams for their transmissions (e.g., UL or SL). Such a relationship could be configured as TCI state as shown in Table 1 or Table 2 as examples, and signaled by higher layer signaling such as RRC signaling. For JP, all participating UEs may be configured with a respective TCI state and the aggregated or combined TCI state of the participating UEs could be viewed as an overall TCI state for JP. Such a TCI state for JP could be configured for all participating UEs and could be signaled to a receiver end of a JP transmission, which is a gNB or other network device for uplink or a destination UE for SL JP. Such TCI state configuration can be further indicated dynamically. For dynamic indication, TCI states may be carried in separate or joint DCI/SCI to indicate the QCL relationship between reference signals and DMRS for data transmission or relationship of some reference signals or channels and the associated beams for their transmissions.

For separate DCI or SCI, the DCI or SCI may be UE-specific, or scrambled by a UE-specific identifier such as a radio network temporary identifier (RNTI) for each UE. For joint DCI or SCI, the DCI or SCI may be group-specific, or be scrambled by a group identifier such as a group RNTI. For a group that includes a first participating UE and a second participating UE, for example, both the first UE and the second UE are configured with the same group-specific RNTI.

QCL information of reference signal and DMRS could facilitate channel estimation and decoding of data and improve JP performance as well as for beam managing/switching for JP transmission.

Turning now to additional detail regarding signaling, DCI for UL or SL (or SCI for SL) may be designed to accommodate JP and corresponding reference signal relationship indication such as QCL. Two alternatives for DCI design are provided below by way of example.

In some embodiments, separate DCI or SCI are used for each UE, including one DCI/SCI for each participating UE. Examples of scheduling information that may be included in each DCI/SCI are provided below, but DCI/SCI are not in any way limited to the following scheduling information. The scheduling information contained in each DCI/SCI may have some mutual restrictions, as noted. Scheduling information for separate DCI/SCI embodiments may be indicative of any one or more of the following:
a set of scheduling resources—should be the same for all participating UEs;
MCS—should be the same for all participating UEs;
total number of transmit layers—should be the same for all participating UEs;
TPMI for CB based JP—If precoding matrix is from a compound codebook, then the TPMI for each UE should be the same, pointing to the same precoding matrix. The DCI/SCI could contain an indication of a portion of the precoding matrix for precoding data streams for this UE, such as a bitmap to indicate rows of the precoding matrix. For example, a bitmap field in respective DCI/SCI may indicate rows of the precoding matrix for UE #1 or UE #2 if two UEs participate in JP;
HARQ process ID and redundancy version (RV)—should be the same for all participating UEs;
SRS resource indicator for corresponding beam—could be different for each UE (where SRS resource is associated with a beam);
TCI, QCL, or other relationship information indicating relationships among reference signals and corresponding beams.

Regarding the last example above, relationship information may include QCL information such as a TCI value in a TCI field. QCL information can indicate relationships between reference signals such as SSB, SRS, CSI-RS, SL CSI-RS and DMRS ports for PUCCH/PUSCH/PSCCH/PSSCH, for example. A TCI value indicates that the DMRS port of PUCCH/PUSCH/PSCCH/PSSCH has a QCL relationship or is in the same beam with the SSB and/or one or more other reference signals or shall be transmitted in the beam associated with the SSB and/or one or more other reference signals.

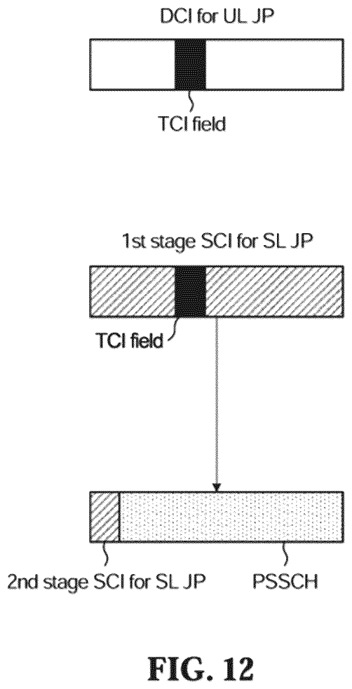

FIG. 12 is a block diagram illustrating example signaling options. The diagram at the top of FIG. 12 illustrates a TCI field in DCI for UL or SL JP. For an SL scenario, QCL information can be carried by a first and/or a second stage of SCI. The two lower diagrams in FIG. 12 show an example in which a TCI field is carried by a first stage of SCI.

Another signaling options involves one joint (or common) DCI (or SCI) for all participating UEs. The joint DCI/SCI could contain, for example, information indicative of any one or more of the following, and may also or instead include other information in other embodiments:
one set of time-frequency resources—used for scheduling all the participating UEs for joint precoding and transmission;
one MCS for all the participating UEs, for channel coding and modulation;
one transmit rank (number of layer) for all the participating UEs for generating a number of data streams (layers);
one set of TPMI (for CB based JP) for all the participating UEs, for applying precoding on data—If the precoding matrix is from a compound code book supporting aggregated antenna ports from all the UE participating JP, for example if UE #1 supports 2-tx and UE #2 supports 2-tx, the joint precoding matrix may be from a codebook supporting aggregated 4-tx, then the DCI could contain an indication of respective portions of the precoding matrix for precoding data streams for each UE, such as a bitmap to indicate rows of the precoding matrix for each UE. A bitmap field may indicate rows of the precoding matrix for UE #1 and a bitmap field to indicate rows of the precoding matrix for UE #2 if two UEs participate in JP, for example; Optionally, the rows of the precoding matrix for each UE to apply its precoding could be determined based on pre-configured antenna ports.
one HARQ process ID and redundancy version (RV) for all participating UEs;
one or more SRS resource indicator (SRI) for corresponding beam—for example, multiple SRIs could be indicated, including one for each UE, to indicate different uplink or sidelink beams used by each UE;
TCI, QCL, or other relationship information indicating relationships among reference signals, such as relationships between reference signals such as SSB, SRS, CSI-RS, SL CSI-RS and DMRS ports for PUCCH/PUSCH/PSCCH/PSSCH, for example. A TCI value indicates that the DMRS port of PUCCH/PUSCH/PSCCH/PSSCH has a QCL relationship or is in the same beam with SSB and/or one or more other reference signals, and may be carried by a TCI field of DCI or by a TCI field of a first stage or second stage of SCI.

For UL or SL JP communications, a joint DCI could be duplicated and transmitted to each UE in separate PDCCH in UE respective search space (SS), or it could be transmitted in one PDCCH in SS of one of the UEs, such as an SUE or primary UE, and can be scrambled by a unique UE identifier such as a radio network temporary identifier (RNTI). For SL JP communications, a joint SCI could be transmitted by the primary UE or SUE to the TUE or destination UE. For example, the first stage of SCI could be transmitted by the primary UE (or SUE) to the TUE, while the second stage of SCI along with PSSCH could be transmitted by all participating UEs to the TUE.

Signaling design such as DCI/SCI design disclosed herein could accommodate both signaling for JP and supplementary information including relationship information such as QCL information.

Any of various other features may be implemented in conjunction with JP as disclosed herein. For example, in some embodiments, UE transmissions with JP could be scheduled not by dynamic grant (DG) but by configured grant (CG). This may be especially useful when data transmissions are more periodic or pre-determined. Also, latency could be an important factor for transmissions, for example, when lower latency is desired/required in data transmission. In this case, normal dynamic scheduling procedures may prove too slow to meet stringent requirements, and CG based transmissions may lower latency. CG transmission is adopted in NR Release-15 for single UE UL transmission.

Joint precoding transmissions by participating UEs can be scheduled by configured grant for both UL and SL scenarios. A configured grant could be sent to the participating UEs in high-layer signaling such as RRC signaling, from a network device such as a gNB, or by a primary UE, or by an SUE.

A configured grant for joint precoding transmissions could include some general configured grant portions or fields that are also used for individual CG based UE transmission. In addition, a configured grant for JP could include, for example, other information such as configurations of one or more parameters such as those referenced elsewhere herein in the context of signaling or DCI/SCI design for JP. In general, CG signaling or signaling that indicates or otherwise includes a configured grant for JP transmission may include information indicative of any one or more the following:
a set of common CG parameters (information) shared by all participating UEs—for example, the same time-frequency scheduling resource, MCS, number of layers, precoding matrix for all participating US, number of HARQ processes, etc.;
each UE may have separate (different) individual CG information—for example, antenna ports configuration for each UE including those for SRS (or SL CSI-RS) and DMRS for PUSCH or PSSCH, which may configure precoding for each UE in some embodiments, and/or QCL information which may include quasi co-location relation and beam relation between {SRS, CSI-RS, SL CSI-RS ports} and {DMRS ports for PUCCH/PUSCH/PSCCH/PSSCH};
UE phase alignment configuration including phase alignment window for aligning the phases among UE for JP;
one or more other parameters to configure a JP transmission.

Other information may also or instead be included in other embodiments.

Table 3 and Table 4 below show configuration examples for CG based JP for UL and SL, respectively, with some entries that are common for all participating UEs and other entries that are more UE specific. The examples for illustration only, and may not show a complete or exact signaling format. These examples also are not exhaustive, and other embodiments may use similar or different signaling formats.

TABLE 3
CG configuration example for UL JP

```
ConfiguredUplinkGrant  {
  ....
(common configuration)
  cg-DMRS-Configuration  DMRS-UplinkConfig,
  mcs-Table
  resourceAllocation
  timeDomainOffset
  timeDomainAllocation
  frequencyDomainAllocation
  dmrs-SeqInitialization
  precodingAndNumberOfLayers
  NrOfHARQ-Processes
  ....
(UE specific configuration)
  antennaPortMapping_UE#1
  antennaPortMapping_UE#2
  srs-ResourceIndicator_UE#1
  srs-ResourceIndicator_UE#2
  ul_TCIState_UE#1
  ul_TCIState_UE#2
  ....
  }
```

TABLE 4
CG configuration example for SL JP

```
ConfiguredsidelinkGrant  {
  ....
(common configuration)
  sl-TimeResourceCG
  sl-FreqResourceCG
  sl-NrOfHARQ-Processes
  ....
(UE specific configuration)
  sl_antennaPortMapping_UE#1
  sl_antennaPortMapping_UE#2
  sl-csi-rs-ResourceIndicator_UE#1
  sl-csi-rs-ResourceIndicator_UE#2
  sl_TCIState_UE#1
  sl_TCIState_UE#2
  ....
  }
```

CG based JP could provide JP transmissions with less latency and be beneficial for more periodic and pre-determined JP transmissions.

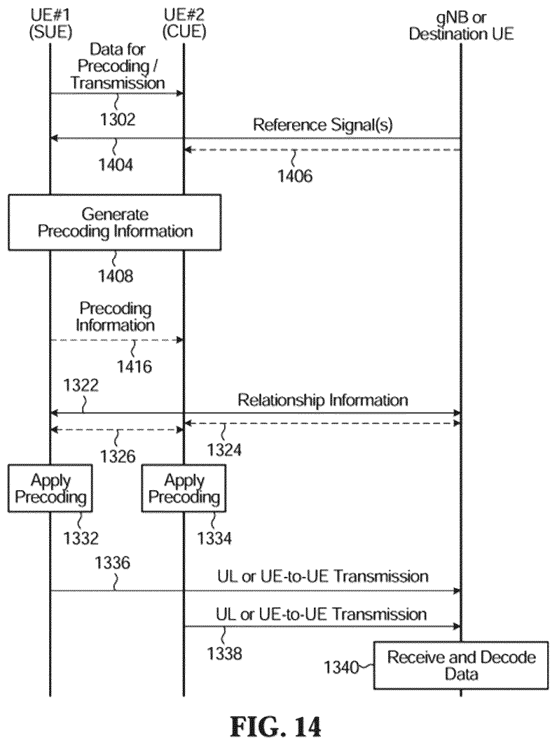

FIG. 13 is a signal flow diagram illustrating an example of signaling and coordinated operation of UEs for joint precoding and transmission of data according to an embodiment. In FIG. 13, a UE #1 is an SUE, and the same data of the SUE is to be jointly precoded and transmitted by UE #1 and a CUE, shown as UE #2. In the illustrated example, operation of UE #1 and UE #2 is to be coordinated for joint precoding and transmission of data to a gNB (UL scenario) or a destination UE (SL or UE-to-UE scenario). FIG. 13, and FIG. 14 described below, are intended as examples only. Variations, with more than two UEs and/or a primary UE that may or may not also participate in coordinated operation for example, are possible.

The data for joint precoding and transmission by UE #1 and UE #2 is SUE data in FIG. 13, and dispatch of the data to UE #2 is shown at 1302. The data may be or include a data block dispatched from a common MAC entity to both UE #1 and UE #2 for joint precoding and transmission. This type of dispatch of data for joint precoding and transmission relates to one embodiment, and is also shown by way of example in FIG. 7.

At 1304, FIG. 13 illustrates reference signals being communicated between the UE #1 and the gNB or destination UE. Some embodiments involve one UE, such as a primary UE, transmitting one or more reference signals, and the gNB or destination UE receiving the reference signal(s), at 1304. Other embodiments may involve multiple UEs such as all participating UEs transmitting one or more reference signals, and the gNB or destination UE receiving the reference signal(s), at 1304, 1306.

The example in FIG. 13 involves the gNB or destination UE generating precoding information at 1308, and transmitting the precoding information to one or more of the participating UEs at 1302, 1314. The precoding information may be transmitted only to a primary UE, for example UE #1, at 1312, or to all participating UEs, at 1312, 1314. At 1316, FIG. 13 illustrates that precoding information may be received by one UE (UE #1 in this example) at 1312 and transmitted to another UE (UE #2 in this example) at 1316.

Similarly, relationship information may be communicated between a gNB or destination device and one of the participating UEs (at 1322) or more than one of the participating UEs (at 1322, 1324). In embodiments in which relationship information is communicated between fewer than all participating UEs and the gNB or destination UE, the relationship information may be communicated between participating UEs, as shown at 1326. Communicating relationship information may involve transmitting the relationship information by one or more UEs and receiving the relationship information by the gNB or destination UE, or transmitting the relationship information by the gNB or destination UE and receiving the relationship information by one or more UEs.

Therefore, relationship information may be communicated from a communication device such as a gNB or a destination UE to one or more UEs, or from one or more UEs to such a communication device. For example, for UL, the gNB in FIG. 13 could send relationship information to either or both of UE #1 and UE #2. In another example, for SL, UE #1 and UE #2 could send relationship information to the destination UE.

Each participating UE performs part of joint precoding, and FIG. 13 illustrates each UE applying precoding to the data as part of the joint precoding at 1332, 1334. The precoding applied by each UE is consistent with joint precoding indicated by the precoding information received by UE #1 at 1312, and by UE #2 at 1324 or 1326 in the example shown.

Transmission of the data after precoding is shown at 1336, 1338. The joint transmission at 1336 and 1338 from UE #1 and UE #2 is scheduled on the same time-frequency resources in some embodiments. Joint transmission may be scheduled by dynamic grant or pre-configured grant, for example. Data transmission may involve other operations that are not shown in FIG. 13 in order to avoid further congestion in the drawing. Examples of such other operations are shown in FIG. 8. For completeness, FIG. 13 shows the gNB or destination UE receiving and decoding precoded data at 1340.

FIG. 14 is a signal flow diagram illustrating an example of signaling and coordinated operation of UEs for joint precoding and transmission of data according to another embodiment. The example shown in FIG. 14 is substantially similar to the example in FIG. 13, with the exception of precoding information features. In FIG. 13, the gNB or destination UE generates precoding information, whereas in FIG. 14, precoding information is generated by one or both of the UEs. At 1404, 1406, FIG. 14 illustrates the gNB or destination UE transmitting one or more reference signals, and UE #1 and UE #2 receiving the reference signal(s). Each UE receives one or more reference signals from the gNB or destination UE, and is involved in some way in generating joint precoding information at 1408, to determine a precoding matrix or other form of precoder for example, based on the received reference signal(s).

Generating joint precoding information at 1408 uses joint channel information from both UEs in this example and therefore both UEs are involved in some way in the generating at 1408. For example, in an embodiment, one UE (such as the CUE, UE #2) passes the channel information, which it measured or otherwise determined based on the reference signal(s) that it received at 1406, to another UE (such as the SUE, UE #2), and the SUE generates the joint precoding information based on its own channel information and channel information received from other participating UE(s). The generated joint precoding information, or at least a portion of the generated joint precoding information that each other UE needs for joint precoding, is transmitted by the SUE to other participating UEs, shown by way of example at 1416.

UE-generated precoding information may be transmitted by one or more participating UEs and received by the gNB or destination UE, so that the gNB or destination UE will be aware of how the data is to be jointly precoded by the participating UEs. Precoding information generated by a UE need not necessarily be sent to the gNB or destination UE. This is optional, because the gNB or destination UE does not need to know the precoder that is used by the transmitting UEs. This is because DMRS, for example, can be transmitted by the transmitting UE using the same precoding information as used for the data, and thus it can be used at a receiving device to estimate the channel and decode the data without knowledge of precoding that was applied at a transmit side, by the UEs in this example.

FIGS. 13 and 14 are illustrative of various embodiments. More generally, a method consistent with the present disclosure may involve obtaining precoding data, communicating relationship information, and transmitting data after precoding. For example, in the context of a general scenario that involves a UE for which operation is to be coordinated with a second UE for joint precoding and transmission of data to a communication device such as a network device or a destination UE in a wireless communication network, such a method may involve obtaining, by the first UE, the precoding information indicative of precoding that is to be applied to the data by the first UE as part of the joint precoding. The communicating in such a method may involve communicating the relationship information by the first UE with the communication device, as shown by way of example. The relationship information may, for example, indicate a relationship between different reference signals that are communicated between the first UE and the communication device or a relationship between a reference signal and an antenna beam, which may be referred to as a corresponding antenna beam that corresponds to or is associated with the reference signal, for transmission of the data after the precoding by the first UE. Thus, there may be multiple purposes or uses for relationship information, including to indicate relationships between reference signals to facilitate decoding of jointly precoded and transmitted data by a receiver, and/or to indicate a relationship between a reference signal such as SSB or CSI-RS and an associated antenna beam that is to be used by a UE to transmit precoded data. Reference signals are shown by way of example at 1304, 1306 in FIG. 13 and at 1404, 1406 in FIG. 14, and communicating relationship information is shown by way of example at 1322, 1324, 1326 in FIGS. 13 and 14.

In the context of such a method, any of various features disclosed herein may be provided. For example, any one or more of the following may be provided, in any of various combinations:
the relationship information may be communicated by a UE with a communication device to facilitate decoding of data by the communication device, after the joint precoding and transmission of the data by the UE;
obtaining precoding information by a UE may involve receiving the precoding information, as shown by way of example at 1312, 1314, 1316, 1416 in FIGS. 13 and 14;
in another embodiment, obtaining precoding information by a UE involves generating the precoding information, as shown by way of example at 1408 in FIG. 14;
receiving the precoding information by a UE may involve receiving the precoding information from the communication device as shown by way of example at 1312, 1314 in FIG. 13, from an other UE as shown by way of example at 1316, 1416 in FIGS. 13 and 14, or from a primary UE (not shown in FIGS. 13 and 14) that organizes and may or may not participate in coordinated operation of a first UE and a second UE for joint precoding and the transmission of the data;
the different reference signals or the reference signal referenced above in the context of the relationship information may be or include a reference signal based upon which a precoding matrix for the joint precoding is generated, such as the reference signal(s) shown by way of example at 1304, 1306 in FIG. 13 and at 1404, 1406 in FIG. 14;
the precoding information may be indicative of a common precoding matrix and a portion of the common precoding matrix that is to be used by the first UE in applying the precoding as the part of the joint precoding—in some embodiments, all participating UEs use respective portions of the same precoding matrix for precoding the data;
each participating UE may use a separate but related precoding matrix for precoding the data, as described by way of example above with reference to the first and third rows of a precoding matrix in FIG. 9 forming a new precoding matrix for UE #1 and the second and fourth rows of the precoding matrix could form a separate precoding matrix for UE #2, and accordingly the precoding information may be indicative of a first precoding matrix that is to be used by the first UE in applying the precoding as the part of the joint precoding and is different from a second precoding matrix that is to be used by the second UE in applying precoding as part of the joint precoding;
the relationship between different reference signals may be a QCL relationship, for example;
the relationship information may be or include TCI signaling, which refers to signaling that includes or indicates TCI information such as a TCI state;
obtaining or receiving precoding information may involve receiving DCI or SCI that indicates the precoding information;
communicating relationship information may involve any one or more of: receiving DCI that indicates the relationship information, receiving SCI that indicates the relationship information, and transmitting SCI that indicates the relationship information (for example, SCI that includes or otherwise indicates the relationship information may be transmitted by a participating UE to a destination UE and/or to an other UE, and all of these options are shown at 1322, 1324, 1326 in FIGS. 13 and 14);
communicating relationship information may involve receiving DCI that further indicates the relationship information, in addition to the precoding information—in other words, communicating relationship information may involve receiving DCI that includes or otherwise indicates both the precoding information and the relationship information, or the same DCI may include or otherwise indicate both the precoding information and the relationship information;
communicating relationship information may involve receiving and/or transmitting the relationship information in the same SCI as the precoding information—in other words, communicating relationship information may involve receiving and/or transmitting SCI that further indicates the relationship information, in addition to the precoding information, or the same SCI may include or otherwise indicate both the precoding information and the relationship information;
put another way, the DCI or SCI that includes or otherwise indicates precoding information may further indicate relationship information;
the communicating may involve: receiving or transmitting higher layer signaling indicating a plurality of relationship information including the relationship information, such as multiple TCI states; and receiving or transmitting DCI or SCI indicating a selection of the relationship information from the plurality of relationship information—for example, relationship information may be configured using higher layer signaling such as RRC signaling to configure different reference signal relationships as a set of TCI states and then DCI or SCI can be used to select one of them;
receiving DCI, by a first UE, may involve receiving DCI from the communication device, or from the second UE—for example, one UE may receive DCI from the communication device and transmit the received DCI to an other UE so that the other UE does not also need to search for DCI from the communication device;
a method may thus involve a first UE receiving DCI and transmitting the DCI, by relaying the received DCI for example, to a second UE;
DCI or SCI may be or include separate DCI or SCI transmitted only to one UE such as the above-referenced first UE, or joint DCI or SCI transmitted to several or all participating UEs including the above-referenced first UE and second UE;
the obtaining may involve receiving, by the first UE, scheduling information in DCI or SCI, with the scheduling information including first scheduling information that is the same as scheduling information for the second UE, and second scheduling information that is different from scheduling information for the second UE;
the first scheduling information may include, for example, any one or more of time-frequency resource, modulation and coding rate, number of data layers for the joint precoding, redundancy version of HARQ, and a precoding matrix for the joint precoding;
the second scheduling information may include, for example, any one or more of: TCI state indication, and a portion of the precoding matrix to be used by the first UE in applying the precoding as the part of the joint precoding;
data may be or include a data block dispatched from a common MAC entity to participating UEs, such as the above-referenced first UE and second UE, for joint precoding and transmission—this is shown by way of example in FIGS. 7 and 8;
obtaining precoding information and communicating relationship information may involve receiving signaling that includes or otherwise indicates the precoding information and the relationship information;
the signaling may also include or otherwise indicate a configured grant for the joint precoding and transmission;
the communication device to which jointly precoded data is transmitted may be a network device or a UE.

in the present disclosure, the data after the joint precoding and transmission or the transmitted data after the joint precoding means data to be received by the receiving side; the data after the joint precoding means data to be transmitted by the transmitting side; and the data means data to be joint precoded and to be transmitted from the transmitting side, or means data after decoding from the receiving side.

Another method, from the perspective of a communication device, such as a network device or destination UE to which jointly precoded data is transmitted by multiple UEs, may involve communicating, by the communication device in the wireless communication network, relationship information indicating: a relationship between different reference signals that are communicated between the communication device and each UE of a plurality of UEs for which operation is to be coordinated for joint precoding and transmission of data to the communication device, or a relationship between a reference signal and an antenna beam for the transmission of the data to the communication device by each UE of the plurality of UEs after precoding of the data by each UE of the plurality of UEs as part of the joint precoding; and receiving, by the communication device from the plurality of UEs, the data after the joint precoding and transmission of the data by the plurality of UEs. Reference signals are shown by way of example at 1304, 1306 in FIG. 13 and at 1404, 1406 in FIG. 14, and communicating relationship information by a communication device such as a network device or a destination UE is shown by way of example at 1322, 1324 in FIGS. 13 and 14.

In the context of such methods, any of various features disclosed herein may be provided. For example, any one or more of the following may be provided, in any of various combinations:
the relationship information may be communicated to facilitate decoding of the data by the communication device;
a method may involve generating, by the communication device, precoding information indicative of the precoding that is to be applied to the data by each UE of the plurality of UEs as part of the joint precoding, as shown by way of example at 1308 in FIG. 13;
some embodiments may involve transmitting, by the communication device, the precoding information, as shown by way of example at 1312, 1314 in FIG. 13;
transmitting precoding information may involve transmitting the precoding information to each UE of the plurality of UEs such as at 1312, 1314 in FIG. 13, to fewer than all UEs of the plurality of UEs such as at only 1312 in FIG. 13, or to a primary UE (not shown in FIGS. 13 and 14) that organizes and may or may not participate in coordinated operation of the plurality of UEs for the joint precoding and the transmission of the data;
the precoding information may be indicative of a common precoding matrix and a portion of the common precoding matrix that is to be used by each UE of the plurality of UEs as part of the joint precoding—in some embodiments, all participating UEs use respective portions of the same precoding matrix for precoding the data;
the participating UEs may use separate but related precoding matrices for precoding the data, as described by way of example above with reference to the first and third rows of a precoding matrix in FIG. 9 forming a new precoding matrix for UE #1 and the second and fourth rows of the precoding matrix could form a separate precoding matrix for UE #2, and accordingly the precoding information may be indicative of respective different precoding matrices that are to be used in precoding of the data by each UE of the plurality of UEs as part of the joint precoding;
the different reference signals or the reference signal referenced above in the context of the relationship information may be or include a reference signal based upon which a precoding matrix for the joint precoding is generated, such as the reference signal(s) shown by way of example at 1304, 1306 in FIG. 13 and at 1404, 1406 in FIG. 14;
the relationship between different reference signals may be a QCL relationship, for example;
the relationship information may be or include TCI signaling, which refers to signaling that includes or indicates TCI information such as a TCI state;
transmitting the precoding information may involve transmitting DCI or SCI indicating the precoding information;
communicating relationship information may involve any one or more of: transmitting DCI indicating the relationship information, receiving SCI indicating the relationship information, and transmitting SCI indicating the relationship information;
communicating relationship information may involve transmitting DCI that further indicates the relationship information, in addition to the precoding information—in other words, communicating relationship information may involve receiving DCI that includes or otherwise indicates both the precoding information and the relationship information, or the same DCI may include or otherwise indicate both the precoding information and the relationship information;
communicating relationship information may involve receiving and/or transmitting the relationship information in the same SCI as the precoding information—in other words, communicating relationship information may involve receiving and/or transmitting SCI that further indicates the relationship information, in addition to the precoding information, or the same SCI may include or otherwise indicate both the precoding information and the relationship information;
put another way, the DCI or SCI that includes or otherwise indicates precoding information may further indicate relationship information;
communicating relationship information may involve receiving and/or transmitting the relationship information in the same SCI as the precoding information—in other words, communicating relationship information may involve receiving and/or transmitting SCI that further indicates the relationship information, in addition to the precoding information, or the same SCI may include or otherwise indicate both the precoding information and the relationship information;
put another way, the DCI or SCI that includes or otherwise indicates precoding information may further indicate relationship information;
the communicating may involve: transmitting or receiving higher layer signaling indicating a plurality of relationship information including the relationship information, such as multiple TCI states; and transmitting or receiving DCI or SCI indicating a selection of the relationship information from the plurality of relationship information;
transmitting DCI, by the communication device, may involve transmitting DCI from the communication device to one UE, such as to either the first UE or the second UE at 1322 or 1324 in FIGS. 13 and 14, for example;
transmitting DCI, by the communication device, may involve transmitting DCI from the communication device to each participating UE, such as to both the first UE and the second UE at 1322 and 1324 in FIGS. 13 and 14, for example;
DCI or SCI may be or include separate DCI or SCI transmitted only to one UE such as the above-referenced first UE, or joint DCI or SCI transmitted to several or all participating UEs including the above-referenced first UE and second UE;
transmitting precoding information may involve transmitting, by the communication device, scheduling information in DCI or SCI, with the scheduling information including first scheduling information that is the same for the first UE and the second UE, and second scheduling information that is different for the first UE and the second UE;
the first scheduling information may include, for example, any one or more of time-frequency resource, modulation and coding rate, number of data layers for the joint precoding, redundancy version of HARQ, and a precoding matrix for the joint precoding;
the second scheduling information may include, for example, any one or more of: TCI state indication, and a portion of the precoding matrix to be used by the first UE in applying the precoding as the part of the joint precoding;
data may be or include a data block dispatched from a common MAC entity to participating UEs, such as the above-referenced first UE and second UE, for joint precoding and transmission—this is shown by way of example in FIGS. 7 and 8;
communicating relationship information may involve transmitting signaling that includes or otherwise indicates the relationship information;
the signaling may also include or otherwise indicate a configured grant for the joint precoding and transmission;
the communication device by which jointly precoded and transmitted data is received may be a network device or a UE.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor and a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to or to cause a processor to obtain, by a first UE for which operation is to be coordinated with a second UE for joint precoding and transmission of data to a communication device, precoding information indicative of precoding that is to be applied to the data by the first UE as part of the joint precoding; communicate, by the first UE with the communication device, relationship information indicating a relationship between different reference signals that are communicated between the first UE and the communication device or a relationship between a reference signal and an antenna beam for the transmission of the data after the precoding; and transmit, by the first UE to the communication device, the data after the precoding has been applied to the data by the first UE.

Embodiments related to such an apparatus or non-transitory computer readable storage media may include any one or more of the following features, for example, which are also discussed elsewhere herein:
the relationship information may be communicated by the first UE with the communication device to facilitate decoding of the data by the communication device after the joint precoding and transmission;
the programming may include instructions to, or to cause the processor to, obtain the precoding information by receiving the precoding information;
in another embodiment, the programming includes instructions to, or to cause the processor to, obtain the precoding information by generating the precoding information;
the programming may include instructions to, or to cause the processor to, receive the precoding information from the communication device, from the second UE, or from a primary UE that organizes and may or may not participate in coordinated operation of a first UE and a second UE for joint precoding and the transmission of the data;
the different reference signals or the reference signal referenced above in the context of the relationship information may be or include a reference signal based upon which a precoding matrix for the joint precoding is generated;
the precoding information may be indicative of a common precoding matrix and a portion of the common precoding matrix that is to be used by the first UE in applying the precoding as the part of the joint precoding;
the precoding information may be indicative of a first precoding matrix that is to be used by the first UE in applying the precoding as the part of the joint precoding and is different from a second precoding matrix that is to be used by the second UE in applying precoding as part of the joint precoding;
the relationship between different reference signals may be a QCL relationship, for example;
the relationship information may be or include TCI signaling;
the programming may include instructions to, or to cause a processor to, obtain the precoding information by receiving DCI or SCI indicating the precoding information;
the programming may include instructions to, or to cause a processor to, communicate relationship information by any one or more of: receiving DCI indicating the relationship information, receiving SCI indicating the relationship information, and transmitting SCI indicating the relationship information;
the programming may include instructions to, or to cause a processor to, communicate relationship information in the same DCI as the precoding information;
the programming may include instructions to, or to cause a processor to, communicate relationship information by receiving and/or transmitting the relationship information in the same SCI as precoding information;
DCI or SCI indicating precoding information may further indicate relationship information;
the programming may include instructions to, or to cause a processor to, communicate the relationship information by: receiving or transmitting higher layer signaling indicating a plurality of relationship information including the relationship information; and receiving or transmitting DCI or SCI indicating a selection of the relationship information from the plurality of relationship information;
the programming may include instructions to, or to cause a processor to, receive DCI by receiving DCI from the communication device or from the second UE;
the programming may include instructions to, or to cause a processor to, transmit the DCI to a second UE;
DCI or SCI may be or include separate DCI or SCI transmitted only to one UE such as the above-referenced first UE, or joint DCI or SCI transmitted to several or all participating UEs including the above-referenced first UE and second UE;
the programming may include instructions to, or to cause a processor to, obtain the precoding information by receiving, by the first UE, scheduling information in DCI or SCI, with the scheduling information including first scheduling information that is the same as scheduling information for the second UE, and second scheduling information that is different from scheduling information for the second UE;
the first scheduling information may include, for example, any one or more of time-frequency resource, modulation and coding rate, number of data layers for the joint precoding, redundancy version of HARQ, and a precoding matrix for the joint precoding;
the second scheduling information may include, for example, any one or more of: TCI state indication, and a portion of the precoding matrix to be used by the first UE in applying the precoding as the part of the joint precoding;
data may be or include a data block dispatched from a common MAC entity to participating UEs, such as the above-referenced first UE and second UE, for joint precoding and transmission—this is shown by way of example in FIGS. 7 and 8;
the programming may include instructions to, or to cause a processor to, obtain the precoding information and communicate the relationship information by receiving signaling that includes or otherwise indicates the precoding information and the relationship information;
the signaling may also include or otherwise indicate a configured grant for the joint precoding and transmission;
the communication device to which jointly precoded data is transmitted may be a network device or a UE.

In another embodiment, programming may include instructions to or to cause a processor to communicate, by a communication device, relationship information indicating: a relationship between different reference signals that are communicated between the communication device and each UE of a plurality of UEs for which operation is to be coordinated for joint precoding and transmission of data to the communication device, or a relationship between a reference signal and an antenna beam for the transmission of the data to the communication device by each UE of the plurality of UEs after precoding of the data by each UE of the plurality of UEs as part of the joint precoding; and receive, by the communication device from the plurality of UEs, the transmitted data after the joint precoding by the plurality of UEs.

Embodiments related to apparatus or non-transitory computer readable storage media may include any one or more of the following features, for example, which are also discussed elsewhere herein:
the relationship information is communicated by the first UE with the communication device to facilitate decoding of the data by the communication device;
the programming may include instructions to, or to cause a processor to, generate, by the communication device, precoding information indicative of the precoding that is to be applied to the data by each UE of the plurality of UEs as part of the joint precoding;
the programming may include instructions to, or to cause a processor to, transmit, by the communication device, the precoding information;
the programming may include instructions to, or to cause a processor to, transmit the precoding information to each UE of the plurality of UEs, to fewer than all UEs of the plurality of UEs, or to a primary UE that organizes and may or may not participate in coordinated operation of the plurality of UEs for the joint precoding and the transmission of the data;
the precoding information may be indicative of a common precoding matrix and a portion of the common precoding matrix that is to be used by each UE of the plurality of UEs as part of the joint precoding;
the precoding information may be indicative of respective different precoding matrices that are to be used in precoding of the data by each UE of the plurality of UEs as part of the joint precoding;
the different reference signals or the reference signal referenced above in the context of the relationship information may be or include a reference signal based upon which a precoding matrix for the joint precoding is generated;
the relationship between different reference signals may be a QCL relationship, for example;
the relationship information may be or include TCI signaling;
the programming may include instructions to, or to cause a processor to, transmit the precoding information by transmitting DCI or SCI indicating the precoding information;
the programming may include instructions to, or to cause a processor to, communicate relationship information by any one or more of: transmitting DCI indicating the relationship information, receiving SCI indicating the relationship information, and transmitting SCI indicating the relationship information;
the programming may include instructions to, or to cause a processor to, transmit the relationship information in the same DCI as the precoding information;
the programming may include instructions to, or to cause a processor to, receive and/or transmit the relationship information in the same SCI as the precoding information;
the DCI or the SCI that indicates precoding information may further indicate relationship information;
the programming may include instructions to, or to cause a processor to, transmit or receive higher layer signaling indicating a plurality of relationship information including the relationship information; and transmit or receive DCI or SCI indicating a selection of the relationship information from the plurality of relationship information;
the programming may include instructions to, or to cause a processor to, transmit in DCI by transmitting the DCI from the communication device to either the first UE or the second UE;
the programming may include instructions to, or to cause a processor to, transmit DCI by transmitting the DCI from the communication device to each participating UE, such as to each of the first UE and the second UE referenced above;
DCI or SCI may be or include separate DCI or SCI transmitted only to one UE such as the above-referenced first UE, or joint DCI or SCI transmitted to several or all participating UEs including the above-referenced first UE and second UE;
the programming may include instructions to, or to cause a processor to, transmit the precoding information by transmitting scheduling information in DCI or SCI, wherein the scheduling information comprises: first scheduling information that is the same for the first UE and the second UE, and second scheduling information that is different for the first UE and the second UE;
the first scheduling information may include, for example, any one or more of time-frequency resource, modulation and coding rate, number of data layers for the joint precoding, redundancy version of HARQ, and a precoding matrix for the joint precoding;
the second scheduling information may include, for example, any one or more of: TCI state indication, and a portion of the precoding matrix to be used by the first UE in applying the precoding as the part of the joint precoding;
data may be or include a data block dispatched from a common MAC entity to participating UEs, such as the above-referenced first UE and second UE, for joint precoding and transmission—this is shown by way of example in FIGS. 7 and 8;
the programming may include instructions to, or to cause a processor to, communicate relationship information by transmitting signaling that includes or otherwise indicates the relationship information;
the signaling may also include or otherwise indicate a configured grant for the joint precoding and transmission;
the communication device by which jointly precoded and transmitted data is received may be a network device or a UE.

Other features disclosed herein may also or instead be implemented in apparatus embodiments and/or in computer program product embodiments.

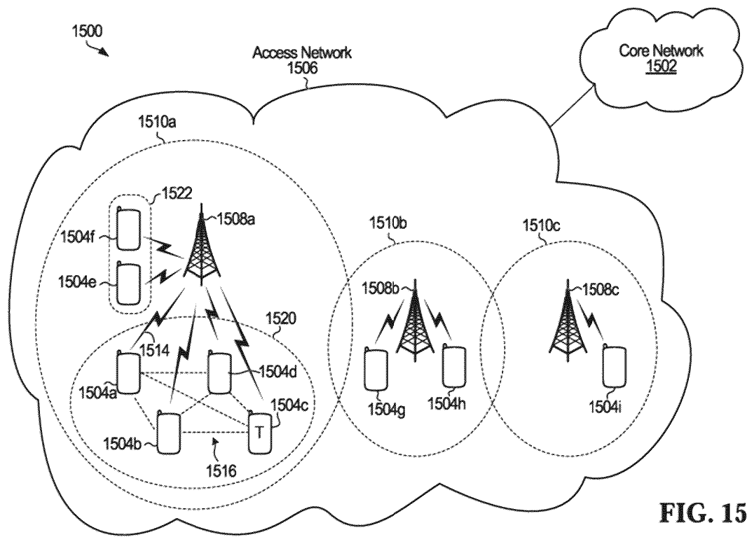

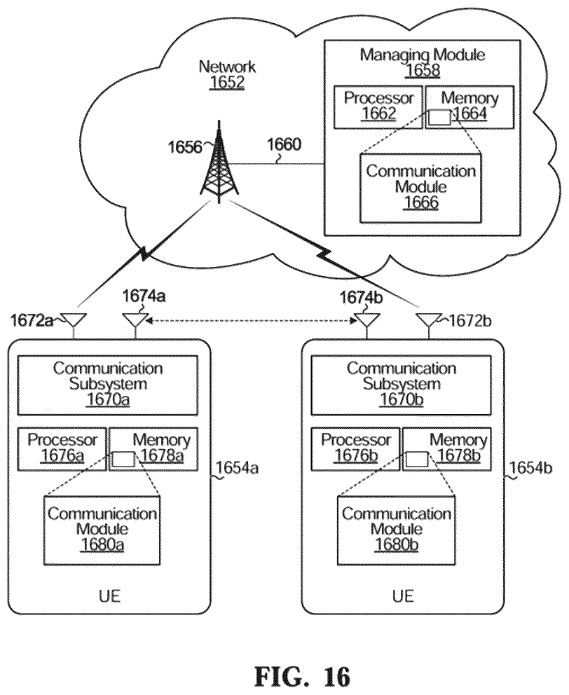

FIGS. 1 to 6, 10, and 11 provide examples of communication systems and devices in which, or in conjunction with which, embodiments disclosed herein may be implemented. Additional network examples are shown in FIGS. 15 and 16.

FIG. 15 is a block diagram illustrating an example of a telecommunications network 1500 according to one embodiment. The telecommunications network 1500 includes a core network 1502 and a radio access network 1506. The radio access network 1506 serves a plurality of UEs 1504a, 1504b, 1504c, 1504d, 1504e, 1504f, 1504g, 1504h, and 1504i. The access network 1506 is an Evolved Universal Terrestrial Access (E-UTRA) network in some embodiments. Another example of a radio access network 1506 is a cloud access network (C-RAN). The radio access network 1506 includes a plurality of BSs 1508a, 1508b, and 1508c. The BSs 1508a-c each provide a respective wireless coverage area 1510a, 1510b, and 1510c, also referred to as a cell. Each of the BSs 1508a-c could be implemented using a radio transceiver, one or more antennas, and associated processing circuitry, such as antenna radio frequency (RF) circuitry, one or more analog-to-digital converters, one or more digital-to-analog converters, etc.

Although not illustrated, the BSs 1508a-c are each connected to the core network 1502, either directly or through one or more central processing hubs, such as servers. The BSs 1508a-c could serve as a gateway between the wireline and wireless portion of the access network 1506.

Each one of BSs 1508a-c may instead be referred to as a base transceiver station, a radio BS, a network node, a transmit node, a transmit point, a Node B, an eNode B, a remote radio head (RRH), or otherwise, depending upon the implementation.

In operation, the plurality of UEs 1504a-i access the telecommunications network 1500 using the access network 1506 by wirelessly communicating with one or more of the BSs 1508a-c.

UEs 1504a-d are in close proximity to each other. Although the UEs 1504a-d can each wirelessly communicate with the BS 1508a, they can also directly communicate with each other, as represented at 1516. The communications represented at 1516 are direct communications between UEs, such as sidelink communications, that do not go through an access network component, such as a BS. Such communications between UEs are also referred to herein as UE-to-UE communications or inter-UE communications. As shown in FIG. 15, UE-to-UE communications 1516 are directly between the UEs 1504a-d and are not routed through the BS 1508a, or any other part of the access network 1506. Communications 1516 may also be referred to as lateral communications. In embodiments disclosed herein, UE-to-UE communications may use a sidelink channel and a sidelink air interface. On the other hand, a communication between an access network component, such as BS 1508a, and a UE, as in communication 1514, is called an access communication. An access communication occurs over an access channel, which can be an uplink or downlink channel, and an access communication uses a radio access communication interface, such as a cellular radio access air interface. Access and inter-UE air interfaces may use different transmission formats, such as different waveforms, different multiple access schemes, or different radio access technologies. Some examples of radio access technologies that could be used by an access air interface or an inter-UE air interface are: Long Term Evolution (LTE), LTE License Assisted Access (LTE-LAA), and WiFi.

By using the sidelink (or other inter-UE) communications 1516, the UEs 1504a-d may be able to assist with wireless communications between the UEs 1504a-d and the BS 1508a. As one example, if UE 1504c fails to correctly decode a packet received from the BS 1508a but UE 1504d is able to receive and correctly decode the packet from the BS 1508a, then UE 1504d could directly transmit the decoded packet to UE 1504c using UE-to-UE communications 1516. As another example, if UE 1504c moves out of wireless coverage area 1510a, such that UE 1504c can no longer wirelessly communicate with the BS 1508a, then UE 1504b could forward messages between the UE 1504c and the BS 1508a. As another example, UE 1504a and UE 1504c could both receive a signal transmitted from the BS 1508a that carries a packet meant for UE 1504c. UE 1504a may then transmit to UE 1504c, via UE-to-UE communications 1516, the signal as received by UE 1504a. UE 1504c may then use the information received from UE 1504a to help decode the packet from the BS 1508a. In these examples, UE operation is coordinated to assist one or more of the UEs 1504a, 1504b, and 1504d.

The UEs 1504a-d form a UE group 1520 in some embodiments. It should be noted, however, that features as disclosed herein are not dependent upon UE groups being explicitly formed in advance.

In UE group 1520 and a scenario in which the UE 1504c is to be assisted, the other UEs 1504a, 1504b, and 1504d form a candidate set for assisting the UE 1504c. If UEs 1504a and 1504b assist the UE 1504c, then the UEs 1504a and 1504b form what may be called a coordination active set, or in UC embodiments a cooperation active set. As UEs 1504a-d move around, some may leave the UE group 1520. UE movement may also or instead result in other UEs joining the UE group 1520. Therefore, the candidate set may change over time. For example, the candidate set may change semi-statically. The UE group 1520 may also be terminated by the network 1506, for example, if the network determines that there is no longer a need or opportunity for the UE group 1520 to provide assistance in wireless communication between the BS 1508a and members of the UE group 1520.

There may be more than one UE group. For example, UEs 1504e and 1504f in FIG. 15 form another UE group 1522.

FIG. 16 is a block diagram illustrating an example of a network 1652 serving two UEs 1654a and 1654b, according to one embodiment. The network 1652 may be the access network 1506 from FIG. 15, and the two UEs 1654a and 1654b may be two of the four UEs 1504a-d in FIG. 15, or the UEs 1654a and 1654b may be UEs 1504e and 1504f in FIG. 15. However, more generally this need not be the case, which is why different reference numerals are used in FIG. 16.

The network 1652 includes a BS 1656 and a managing module 1658. The managing module 1658 instructs the BS 1656 to perform actions. The managing module 1658 is illustrated as physically separate from the BS 1656 and coupled to the BS 1656 via a communication link 1660. For example, the managing module 1658 may be part of a server in the network 1652. Alternatively, the managing module 1658 may be part of the BS 1656.

The managing module 1658 includes a processor 1662, a memory 1664, and a communication module 1666. The communication module 1666 is implemented by the processor 1662 when the processor 1662 accesses and executes a series of instructions stored in the memory 1664, the instructions defining the actions of the communication module 1666. When the instructions are executed, the communication module 1666 causes the BS 1656 to perform the actions described herein so that the network 1652 can, in some embodiments, establish, instruct, or control coordinated operation of UEs. Alternatively, the communication module 1666 may be implemented using dedicated circuitry, such as an application specific integrated circuit (ASIC) or a programmed field programmable gate array (FPGA).

The UE 1654a includes a communication subsystem 1670a, two antennas 1672a and 1674a, a processor 1676a, and a memory 1678a. The UE 1654a also includes a communication module 1680a. The communication module 1680a is implemented by the processor 1676a when the processor 1676a accesses and executes a series of instructions stored in the memory 1678a, the instructions defining the actions of the communication module 1680a. When the instructions are executed, the communication module 1680a causes the UE 1654a to perform actions described herein in relation to coordinated operation of UEs. Alternatively, the module 1680a may be implemented by dedicated circuitry, such as an ASIC or an FPGA.

The communication subsystem 1670a includes processing circuitry, transmit circuitry, and receive circuitry for sending messages from and receiving messages at the UE 1654a. Although one communication subsystem 1670a is illustrated, the communication subsystem 1670a may be multiple communication subsystems. Antenna 1672a transmits wireless communication signals to, and receives wireless communications signals from, the BS 1656. Antenna 1674a transmits inter-UE communication signals to, and receives inter-UE communication signals from, other UEs, including UE 1654b. In some implementations there may not be two separate antennas 1672a and 1674a. A single antenna may be used. Alternatively, there may be several antennas, but not separated into antennas dedicated only to inter-UE communication and antennas dedicated only to communicating with the BS 1656.

Inter-UE communications could be over Wi-Fi, in which case the antenna 1674a may be a Wi-Fi antenna. Alternatively, the inter-UE communications could be over Bluetooth™, in which case the antenna 1674a may be a Bluetooth™ antenna. Inter-UE communications could also or instead be over licensed or unlicensed spectrum.

The UE 1654b includes the same components described above with respect to the UE 1654a. That is, UE 1654b includes communication subsystem 1670b, antennas 1672b and 1674b, processor 1676b, memory 1678b, and communication module 1680b.

FIGS. 15 and 16 illustrate systems in which embodiments could be implemented. In some embodiments, a UE includes a processor, such as 1676a, 1676b in FIG. 16, and a non-transitory computer readable storage medium, such as 1678a, 1678b in FIG. 16, storing programming comprising instructions for execution by the processor. A non-transitory computer readable storage medium could also or instead be provided separately, as a computer program product. Examples are provided elsewhere herein.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Features disclosed herein in the context of method embodiments, for example, may also or instead be implemented in apparatus or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

1. A method comprising:
obtaining, by a first user equipment (UE) to be coordinated with a second UE for joint precoding and transmission of data to a communication device, precoding information indicating precoding to be applied to the data by the first UE as part of the joint precoding;
communicating, by the first UE with the communication device, relationship information indicating a relationship between different reference signals communicated between the first UE and the communication device or a relationship between a reference signal and an antenna beam for the transmission of the data after the precoding; and
transmitting, by the first UE to the communication device, the data after the precoding has been applied to the data by the first UE.

2. The method of claim 1, wherein the relationship information is communicated by the first UE with the communication device to facilitate decoding of the data by the communication device after the joint precoding and the transmission of the data.

3. The method of claim 1, wherein the obtaining comprises:
receiving the precoding information; or
generating the precoding information.

4. The method of claim 3, wherein the receiving the precoding information comprises:
receiving the precoding information from one of:
the communication device,
the second UE, or
a primary UE that organizes coordination of the first UE and the second UE for the joint precoding and the transmission of the data.

5. The method of claim 1, wherein the different reference signals or the reference signal comprises a reference signal based upon which a precoding matrix for the joint precoding is generated.

6. The method of claim 1, wherein the precoding information indicates:
a common precoding matrix and a portion of the common precoding matrix that is to be used by the first UE in applying the precoding as the part of the joint precoding; or
a first precoding matrix that is to be used by the first UE in applying the precoding as the part of the joint precoding and that is different from a second precoding matrix that is to be used by the second UE in applying precoding as part of the joint precoding.

7. The method of claim 1, wherein the relationship between the different reference signals comprises a quasi co-location (QCL) relationship.

8. A method comprising:
communicating, by a communication device, relationship information indicating:
a relationship between different reference signals that are communicated between the communication device and each user equipment (UE) of a plurality of UEs to be coordinated for joint precoding and transmission of data to the communication device, or
a relationship between a reference signal and an antenna beam for the transmission of the data to the communication device by each UE of the plurality of UEs after precoding of the data by each UE of the plurality of UEs as part of the joint precoding; and
receiving, by the communication device from the plurality of UEs, the data after the joint precoding by the plurality of UEs.

9. The method of claim 8, wherein the relationship information is communicated to facilitate decoding of the data by the communication device.

10. The method of claim 9, further comprising:
generating, by the communication device, precoding information indicating the precoding to be applied to the data by each UE of the plurality of UEs as part of the joint precoding; and
transmitting, by the communication device, the precoding information.

11. The method of claim 10, wherein the transmitting the precoding information comprises:
transmitting the precoding information to:
each UE of the plurality of UEs, to fewer than all UEs of the plurality of UEs, or
a primary UE that organizes coordination of the plurality of UEs for the joint precoding and the transmission of the data.

12. The method of claim 10, wherein the precoding information indicates:
a common precoding matrix and respective portions of the common precoding matrix that is to be used in precoding of the data by each UE of the plurality of UEs as part of the joint precoding; or
respective different precoding matrices that are to be used in the precoding of the data by each UE of the plurality of UEs as part of the joint precoding.

13. The method of claim 8, wherein the different reference signals or the reference signal comprise a reference signal based upon which a precoding matrix for the joint precoding is generated.

14. The method of claim 8, wherein the relationship between the different reference signals comprises a quasi co-location (QCL) relationship.

15. An apparatus comprising:
at least one processor; and
a non-transitory computer readable storage medium, coupled to the processor, storing programming for execution by the processor, the programming including instructions to cause the apparatus to perform:
obtaining, by the apparatus to be coordinated with a second apparatus for joint precoding and transmission of data to a communication device, precoding information indicating precoding to be applied to the data by the apparatus as part of the joint precoding;
communicating, with the communication device, relationship information indicating a relationship between different reference signals communicated between the apparatus and the communication device or a relationship between a reference signal and an antenna beam for the transmission of the data after the precoding; and
transmitting, to the communication device, the data after the precoding has been applied to the data by the apparatus.

16. The apparatus of claim 15, wherein the relationship information is communicated with the communication device to facilitate decoding of the data by the communication device after the joint precoding and the transmission of the data.

17. The apparatus of claim 15, wherein the obtaining comprises:
receiving the precoding information; or
generating the precoding information.

18. The apparatus of claim 17, wherein the receiving the precoding information comprises:
receiving the precoding information from one of
the communication device,
the second apparatus, or
a primary apparatus that organizes coordinated operation of the apparatus and the second apparatus for the joint precoding and the transmission of the data.

19. The apparatus of claim 15, wherein the different reference signals or the reference signal comprise a reference signal based upon which a precoding matrix for the joint precoding is generated.

20. The apparatus of claim 15, wherein the precoding information indicates:
a common precoding matrix and a portion of the common precoding matrix that is to be used by the apparatus in applying the precoding as the part of the joint precoding; or
a first precoding matrix that is to be used by the apparatus in applying the precoding as the part of the joint precoding and that is different from a second precoding matrix that is to be used by the second apparatus in applying precoding as part of the joint precoding.
